(19) United States
(12) Patent Application Publication
(10) Pub. No.: US 2010/0131431 A1
(43) Pub. Date: May 27, 2010

(54) Shipment Order, Freight Order and Tour Builder

(75) Inventors: Andreas Esau, Ostringen (DE); Jens Gottlieb, Schwetzingen (DE); Holger Thiel, St. Leon-Rot (DE)

Correspondence Address: SAP/BSTZ;BLAKELY SOKOLOFF TAYLOR & ZAFMAN LLP, 1279 OAKMEAD PARKWAY, SUNNYVALE, CA, 94085-4040, US

(73) Assignee: SAP AG, Walldorf (DE)

(21) Appl. No.: 12/324,317

(22) Filed: Nov. 26, 2008

(51) Int. Cl. G06Q 10/00; G06Q 90/00

(52) U.S. Cl. 705/500; 705/330

(57) ABSTRACT

The embodiments of the invention relates to a transportation management system. Specifically the embodiments of the invention relate to a system and process for generating shipment orders, freight orders and tours automatically from planned transportation activity data. The process reduces planned transportation activity to a set of frames having minimal data to reduce processing time. The frames are then evaluated for soft and hard constraints to identify a set of shipment orders, freight orders and tours. The shipment orders, freight orders and tours are then augmented from the frame state to include the necessary data.

### BACKGROUND

1. Field of the Invention

The embodiments of the invention relate to a transportation management system. Specifically, the embodiments of the invention relate to a system and process for generating shipment orders, freight orders and tours automatically from planned transportation activity data.

2. Background

Supply chain management includes the field of transportation management. Transportation management includes handling shipment requests that are received from customers or other links in a supply chain. These requests specify that a particular product is to be delivered to a particular location. These shipment requests are then used to generate freight units to fulfill the shipment requests. The freight units are discrete groupings of the product that can be delivered to a target destination to fulfill a request for the product. These freight units then have to be assigned to particular routes and vehicle schedules, which generates a set of data referred to as planned transportation activity (PTA) data. The process of generating the PTA can be an automated process based on the input of shipment requests. However, the PTA must ultimately be turned into a set of shipment orders, freight orders or tours. These are different types of objects that assign a particular vehicle resource to carry freight units between points along the routes specified in the PTA. Currently there is no process where the PTA data is analyzed and divided into one of a shipment order, a freight order or a tour either by a human reviewer or automatically. Thus, it is not possible to consolidate freight units into shipments, complete the delivery of freight units and forward the necessary information to external parties and systems such as transportation service provider, order management system or other entities in a supply chain.

### BRIEF DESCRIPTION OF THE DRAWINGS

Embodiments of the invention are illustrated by way of example and not by way of limitation in the figures of the accompanying drawings in which like references indicate similar elements. It should be noted that different references to “an” or “one” embodiment in this disclosure are not necessarily to the same embodiment, and such references mean at least one.

FIG. 1 is a diagram of one embodiment of a system for generating shipment orders, freight orders or tours.

FIG. 2 is a flowchart of one embodiment of a process for generating shipment orders, freight orders or tours.

FIG. 3 is a diagram of one example illustration of the inter-relationship between freight orders, shipment orders, freight units and vehicle resources, as well as, routes.

FIG. 4 is a diagram of one example illustration of the inter-relationship between tours, freight orders, shipment orders, freight units and vehicle routes.

### DETAILED DESCRIPTION

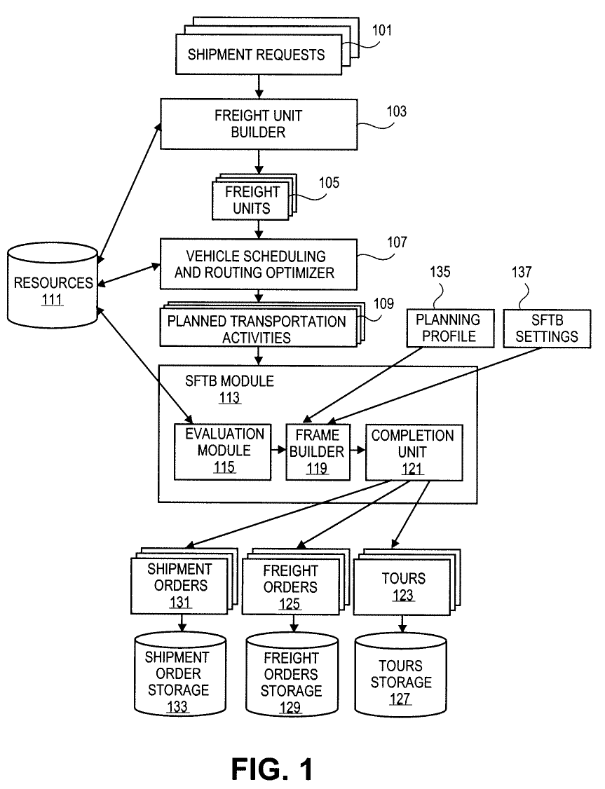

FIG. 1 is a diagram of one embodiment of a system for generating shipment orders, freight orders and tours. The system includes a freight unit builder 103, vehicle scheduling and routing optimizer 107 and the shipment order, freight order and tour builder (SFTB) module 113 as well as, other resources 111 and storage systems 127, 129 133.

The freight unit builder 103 is a software module that receives shipment requests 101 and generates freight units 105. The freight unit builder 103 analyzes incoming shipment requests 101 that may be received from customers or other links or entities in a supply chain such as warehouses, retailers, factories or similar entities. The freight unit builder 103 analyzes the available resources in terms of product shipment sizes, possible routes and similar criteria using information stored in the available resources 111 of the system such as scheduling databases, vehicle resource databases and similar resources. The freight unit builder 103 then identifies discrete freight units for shipping to satisfy each of the requests specified in the shipment requests 101.

The vehicle scheduling and routing optimizer 107 utilizes the output of the freight unit builder 103 along with the other system resources 111 to generate a set of planned transportation activities that route the freight units to their destination in the most efficient manner possible based on a set of routing algorithms and scheduling algorithms. The routes and schedules generated are not tied to specific vehicles. The vehicle and routing optimizer generates planned transportation activity data, which is organized as a data structure with activities that move freight units from point to point in a route.

The shipment order, freight order and tour builder (SFTB) module 113 analyzes each activity in the planned transportation activity data 109 and generates a set of shipment orders 131, freight orders 125 or tours 123 depending on the SFTB settings 137 and planning profile 135. The planning profile 135 and SFTB settings 137 define the parameters under which the SFTB module 113 operates. The planning profile 135 can determine the parameters for defining shipment orders, freight orders and tours. The parameters can include determining which of the three types of objects (shipment order, freight order or tour) are to be generated. The SFTB settings 137 define the parameters of the operation of the SFTB including the operating conditions under which the SFTB operates. These parameters determine how shipment orders, freight orders and tours are to be generated and can define constraints that the SFTB is to consider when it generates these three types of objects.

The shipment order can be defined as an order (i.e., a planning document that directs the use of real-world resources) that fulfills specific criteria within the area of transportation or planning. Freight units are assigned to shipment order items. A shipment order typically has one vehicle resource assigned to it unless passive means of transport such as a trailer are involved. Usually, a shipment order that is generated by SFTB contains one stage representing the transportation of one or more freight units. Thus, the shipment order usually begins with directives for loading the freight unit and ends with directives for the unloading of the freight unit. An exception exists for freight units that are loaded onto a passive means of transportation and are assigned to a shipment order. In this case a shipment order can begin with directives for coupling the passive means of transportation or end with directives for decoupling it. The source location for a shipment order is identical for all shipment order items that are assigned to that shipment order. The destination location is also identical for all the shipment order items that are assigned to the shipment order. A shipment order can also include stages that represent empty runs.

A freight order is defined by a set of criteria related to transportation planning such that the freight order stages represent the transportation of one or more freight units. A freight order can also include stages that represent empty runs. A freight order can contain multiple shipment orders. Each shipment order assigned to a freight order can have a different source location and destination location. If all freight units within a PTA chain are unloaded in a location and other freight units are loaded in this or subsequent locations of the PTA chain, then the SFTB can generate separate freight orders dividing the chain in the location where the freight units are unloaded. A planning profile 135 can specify that the set of freight orders and shipment orders is to be created as opposed to freight orders, shipment orders and tours. The planning profile 135 can also specify that any combination of these objects is to be created. Typically, one vehicle resource is assigned to a freight order. An exception to this rule is the use of passive transportation components such as trailer or box cars in combination with active transportation components such as trucks and trains.

A tour is defined by criteria related to transportation planning. The tour represents movement of a single vehicle resource. A tour defines a single location where the tour starts and defines a single location where the tour ends. The creation of tours can be designated by the planning profile 135. Changing a vehicle resource within a PTA chain requires the splitting of a tour. Thus, the process of identifying and assigning vehicles for a set of tours includes identifying necessary shifts in vehicle resources in a PTA chain. These shifts are then used to define the end of one tour and the start of the next tour. The tours can also include empty runs. These empty runs can be utilized to move a vehicle resource to a next location or return it to an original location even though no freight units are being moved during the empty run segment of the routing and scheduling.

The SFTB settings 137 designate the criteria under which shipment orders, freight orders or tours are to be generated. For example, the SFTB settings 137 can designate that the unloading of all freight units within a PTA chain requires the splitting of the chain into multiple tours for each point where there is a loading or unloading. In another example, the SFTB settings determine whether a freight order has to be generated even if it contains only one shipment order. In a further example, the SFTB settings determine whether or not the empty runs of a vehicle resource shall be assigned to shipment orders or freight orders.

The SFTB module 113 can be a module that is executed by a computer system such as a desktop computer, laptop computer, dedicated server system, distributed computer system or similar computing devices and systems. Any number of computers and computing devices can inter-operate to provide the SFTB module 113. These may be general purpose devices or computing devices designed specifically for this purpose. The SFTB module 113 includes an evaluation module 115, a frame builder 119 and a completion unit 121. The evaluation module 115 analyzes the individual activities in the PTA chain to prepare the PTA data structure for the frame builder 119. This data structure contains only information that is necessary to apply constraints in the frame builder 119. The evaluation module 115 thereby determines the freight units that are to be assigned to a shipment order, freight order or tour. The evaluation module 115 receives PTA, freight units and resources and enables the frame builder 119 to generate shipment order, freight order and tour frames.

The frame builder 119 processes the PTA data to generate frames. Frames are minimal sets of PTA data needed to generate a shipment order, freight order or tour. The PTA data is reduced to a frame to improve processing efficiency. A frame is a minimal set of data required to process hard and soft constraints that are utilized to identify shipment orders, freight orders and tours. The soft constraints are defined by the SFTB settings 137. The frame builder 119 considers these hard and soft constraints. After the shipment order, freight order and tour frames are generated by the frame builder 119, the completion unit 121 gathers the records and data necessary to complete the shipment orders, freight orders and tours from the corresponding resources 111, as well as objects such as freight units 105 and shipment requests 101. Much of this data was removed to create the frames for efficient processing and now must be rejoined to complete shipment orders, freight orders and tours.

The SFTB module 113 can generate any number of shipment orders, freight orders or tours depending on the input PTA data and the planning profile 135 and SFTB settings 137. The shipment orders 131, freight orders 125 and tours 123 that are generated by the SFTB module 113 are stored in respective data structures or databases for storing shipment orders 133, freight orders 129 and tours 127. In one embodiment, these may be separate data structures or data storage systems. In another embodiment, these shipment orders 131, freight orders 125 and tours 123 are stored in a unified storage system, which may be a monolithic data management system or a distributed data management system.

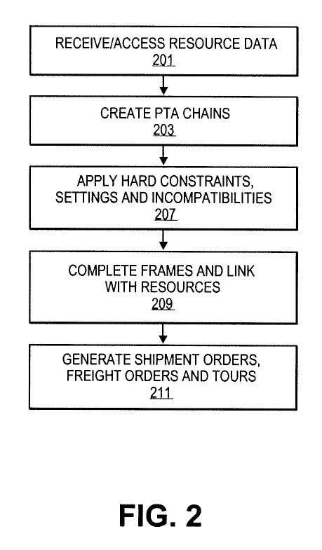

FIG. 2 is a flowchart of one embodiment of a process for generating shipment orders, freight orders and tours. In one embodiment, the process begins by receiving planned transportation activity (PTA) data to be processed. In response to receiving this data, the evaluation module within the SFTB module accesses available resource data or receives this data in conjunction with the PTA data (block 201). The available resource data can include any number of databases or similar resources that include vehicle information, route information, schedule information, product information and similar information. The frame builder within the SFTB module then generates a set of PTA chains which are data structures with the minimum numbers of fields necessary to evaluate the PTA data and generate shipment orders, freight orders and tours (block 203). An absolute minimum of data may not be utilized, but a number of fields approaching this number may be used to maintain the processing efficiency gained by using the reduced set of data for analysis. The activities in the data structure are ordered by start date and end date, start time and end time, and source location and destination location for each step of these routes and activities. The data utilized to populate the PTA chains is drawn from the PTA data and other resource data available to the module.

The frame builder then evaluates each PTA chain based on hard and soft constraints and incompatibilities (block 207). Based on this evaluation, the PTAs flow into separate shipment order, freight order or tour frames. These hard and soft constraints can be any user or programmer defined set or combination of business parameters. For example, constraints can include product or vehicle incompatibility, size and volume constraints, timing constraints, and similar shipping, transportation and business related constraints on the movement and delivery of goods. The hard constraints include the definitions of the shipment orders, freight orders and tours as described above. Any constraint can be designated as a hard constraint. A hard constraint is a criteria for forming a shipment order, freight order or tour that cannot be violated. Any constraint can be designated as a soft constraint. A soft constraint is a criteria that has some level of flexibility in its application by way of an acceptable range, threshold level, preference or weighting to indicate a preference for one configuration over another or similar constraints. Evaluation of these constraints on the PTA data results in the assignment of stages and specific vehicle resources that meet the hard constraints and best fits the soft constraints being assigned to fulfill a shipment order, freight order or tour. This designation is added to the output frame data or similarly correlated with the shipment order, freight order or tour frame.

The frames output by the frame builder do not contain the complete set of information necessary for a proper set of shipment orders, freight orders and tours. Thus, the completion unit draws the necessary information from the PTA data and other available resources (block 209). The completed frames can then be transformed or similarly used to generate the shipment orders, freight orders and tours (block 211). This includes linking the shipment orders, freight orders and tours with the necessary resources in the system (e.g., notifying other system components of the successful handling or generation of shipment orders for purposes of monitoring the system or initiating the process or executing these orders) and storing the shipment orders, freight orders and tours to be utilized later in the transportation management system.

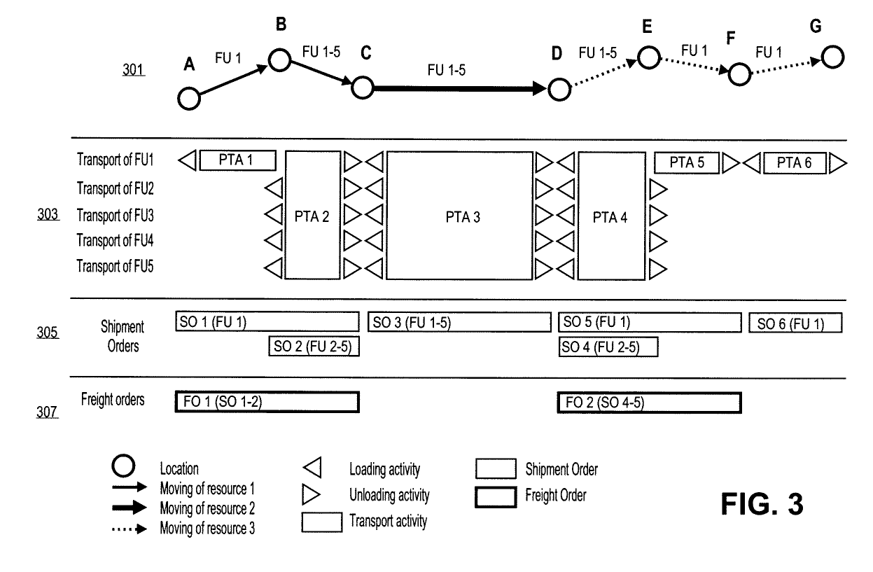

FIG. 3 is a diagram of one example illustration of the inter-relationship between routes, freight units, shipment orders and freight orders. The diagram illustrates a route 301 for transporting a set of freight units to each of their respective destinations. The route 301 includes a set of intermediate destinations designated as locations A-G. Each leg of the route identifies the freight units to be carried over those segments of the route. Different vehicles would be assigned to traverse this route: vehicle 1 would move from location A to location C, vehicle 2 from location C to location D, vehicle 3 from location D to location G. The location and freight unit associations that compose the route are included in the PTA data provided to the SFTB module.

This route 301 is represented also in the diagram of 303. This diagram 303 shows the loading and unloading points for each of the freight units. The first freight unit traverses the entire route while the other freight units are added and dropped over the length of the route. Each segment of the route is defined by specific elements of the PTA data that can be grouped as PTA chain PTA1-PTA6. Diagram 305 illustrates one example embodiment of a set of shipment orders generated to fulfill the requirement of the routes and shipment orders that require the movement of the freight units along this route. These are basic shipment orders that are defined by the load and unload locations for a group of freight units and other soft or hard constraints. The freight orders 307 are illustrated as discrete combinations of the shipment orders that have a common vehicle resource. Some of the shipment orders do not meet the criteria for a freight order and are thus not grouped together into freight orders such as shipment orders SO3 and SO6, which are the only shipment orders for the respective segments and cannot therefore be combined with other shipment orders to form a freight order.

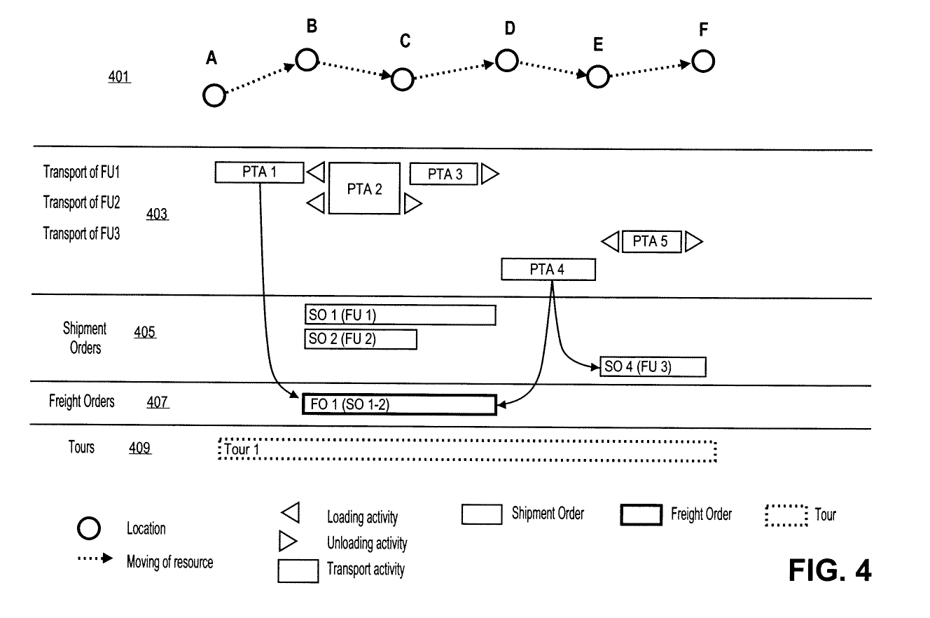

FIG. 4 is another diagram of a similar route and the inter-relationship between shipment orders, freight orders and tours. A route is illustrated in the section of the diagram labeled 401. It shows a route starting from location A and ending at location F. In this example, there are three freight units (whereby freight unit 1 is loaded in location B and unloaded in location D, freight unit 2 is loaded in location B and unloaded in location C, freight unit 3 is loaded in location E and unloaded in location F) and empty runs (represented by PTA1 and PTA 4) that are assigned to this route. The segments of the route corresponding to each of the three freight units and the empty runs are shown in the section 403. The corresponding shipment orders that can be generated to fulfill this movement of freight units are shown in section 405. The corresponding freight orders that could be generated for this route are shown in section 407. Similarly, a corresponding tour is shown in section 409. A tour correlates with a single vehicle. Thus, in this embodiment the same vehicle is utilized to transport all of the freight units over this route even if its configuration may be changed along the route. FIG. 4 also illustrates that one of the empty runs (PTA4) can be a part of the freight order FO1 or a part of the shipment order SO4 (depending on SFTB settings) and is a part of the tour. The other empty run (PTA1) is a part of the freight order FO1 and of the tour.

In one embodiment, the SFTB module and the other components of the system may be implemented as a set of hardware devices. In another embodiment, these components may be implemented in software (e.g., microcode, assembly language or higher level languages). These software implementations may be stored on a computer-readable medium. A “computer-readable” medium may include any medium that can store or transfer information. Examples of a computer-readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method for transportation management comprising:
receiving planned transportation activity data; and
generating a shipment order, freight order or tour automatically by a building module from the planned transportation activity data by application of a user defined business parameter to the transportation activity data.

2. The method of claim 1, further comprising:
ordering the planned transportation activity data based on a start time, end time, location or resource availability; and
generating a planned transportation activity chain from ordered planned transportation activity.

3. The method of claim 2, further comprising:
marshalling data into a shipment order frame, freight order frame or tour frame by a frame builder.

4. The method of claim 3, further comprising:
generating the shipment order frame from the planned transportation activity chain upon identifying a location at which all freight units in the planned transportation activity chain are unloaded or loaded and upon applying a constraint on the planned transportation activity chain by the frame builder.

5. The method of claim 3, further comprising
generating the shipment order frame from the planned transportation activity chain upon identifying a location at which a passive transportation is decoupled and upon applying a constraint on the planned transportation activity chain by the frame builder.

6. The method of claim 3, further comprising:
generating the freight order frame from the planned transportation activity chain upon applying a constraint on the planned transportation activity chain by the frame builder.

7. The method of claim 3, further comprising:
generating the tour frame from the planned transportation activity data upon applying a constraint on the planned transportation activity chain by the frame builder.

8. The method of claim 3, further comprising:
generating the shipment order from the shipment order frame upon marshalling the planned transportation activity, a freight unit, or a shipment request into a shipment order.

9. The method of claim 3, further comprising:
generating the freight order from the freight order frame upon marshalling the planned transportation activity or the shipment order into the freight order.

10. The method of claim 3, further comprising:
generating the tour from the tour frame upon marshalling planned transportation activity data into a tour.

11. A system for transportation management comprising:
a frame builder to generate a shipment order frame, freight order frame or tour frame from a planned transportation activity chain;
an evaluation module coupled to the frame builder, the evaluation module to automatically evaluate and order planned transportation activity data; and
a completion unit coupled to the frame builder, the completion unit to generate a shipment order, freight order or tour from the shipment order frame, freight order frame or tour frame.

12. The system of claim 11, further comprising:
a shipment order storage, freight order storage or tour storage coupled to the completion module to store the shipment order, freight order or tour.

13. The system of claim 11, wherein the completion unit links the shipment order, freight order or tour to an external resource.

14. A computer readable storage medium having stored therein a set of instructions, which when executed cause the computer to perform a set of operations comprising:
evaluating and ordering planned transportation activity data;
automatically generating a shipment order frame, a freight order frame or a tour frame based on a user defined business parameter; and
automatically generating a shipment order, freight order or tour based on the shipment order frame, freight order frame and tour frame.

15. The computer readable storage medium of claim 14, having stored therein a further set of instructions, which when executed cause the computer to perform a set of operations comprising:
reducing the planned transportation activity data to a planned transportation activity chain; and
deriving the shipment order frame, the freight order frame and tour frame from the planned transportation activity chain.

16. The computer readable storage medium of claim 14, having stored therein a further set of instructions, which when executed cause the computer to perform a set of operations comprising:
evaluating the planned transportation activity chain and applying hard and soft constraints to identify the shipment order, freight order or tour.

17. The computer readable storage medium of claim 14, having stored therein a further set of instructions, which when executed cause the computer to perform a set of operations comprising:
completing the shipment order frame, freight order frame or tour frame by insertion of planned transportation activity, freight unit, or shipment request.

19. The computer readable storage medium of claim 15, wherein evaluating the planned transportation activity data includes determining incompatibilities between freight units.
